(19) United States
(12) Patent Application Publication
(10) Pub. No.: US 2013/0262792 A1
(43) Pub. Date: Oct. 3, 2013

(54) MEMORY DEVICE SUPPORT OF DYNAMICALLY CHANGING FREQUENCY IN MEMORY SYSTEMS

(71) Applicants: John E. Barth, JR., Williston, VT (US); Joab D. Henderson, Pflugerville, TX (US); Ryan J. Pennington, Austin, TX (US); Anuwat Saetow, Austin, TX (US); Robert B. Tremaine, Stormville, NY (US); Kenneth L. Wright, Austin, TX (US)

(72) Inventors: John E. Barth, JR., Williston, VT (US); Joab D. Henderson, Pflugerville, TX (US); Ryan J. Pennington, Austin, TX (US); Anuwat Saetow, Austin, TX (US); Robert B. Tremaine, Stormville, NY (US); Kenneth L. Wright, Austin, TX (US)

(73) Assignee: INTERNATIONAL BUSINESS MACHINES CORPORATION, Armonk, NY (US)

(21) Appl. No.: 13/431,108

(22) Filed: Mar. 27, 2012

(51) Int. Cl. G06F 12/00

(52) U.S. Cl. 711/154; 711/E12.001

(57) ABSTRACT

An embodiment is a method includes writing a first set of memory device parameters to a first mode register in a memory device, wherein the first set of memory device parameters correspond to a first frequency, monitoring selected parameters for the memory system while the memory device operates at the first frequency and predicting a second frequency that the memory device will operate at subsequent to the first frequency, the predicting being based on the monitored selected parameters. The method further includes writing a second set of memory device parameters to second mode register in the memory device, receiving a frequency change request at a memory controller associated with the memory device, the frequency change request to operate at a new frequency and updating the first mode register with the second set of memory device parameters from the second mode register responsive to the new frequency being equal to the second frequency.

### BACKGROUND

The present invention relates to memory systems, and more specifically, to memory device support of dynamically changing frequency in memory systems.

Overall computer system performance and power consumption is affected by each of the key elements of the structure of the computer system, including the performance of the processor(s), any memory cache(s), the input/output (I/O) subsystem(s), the efficiency of the memory control function(s), the main memory device(s), and the type and structure of the memory interconnect interface(s).

Power balancing and conservation is an important task for modern computer systems, such as servers, as systems become more complex and consume more resources. For example, servers use frequency scaling on their processors in order to facilitate power balancing. Specifically, in cases where the processor is determined as being underutilized, the processor frequency can be reduced, lowering power consumption of the processor.

As server systems grow in complexity, the amount of memory included in systems has increased significantly. Accordingly, reducing power consumption by the memory may also provide significant power savings for server systems. In some cases, changing the frequency of memory subsystems include powering down and rebooting the memory system, which would require traffic and communication to the memory device to stop for a long period of time. Accordingly, the time that traffic is stopped for this process make it impractical as an option to conserve power in server system.

### SUMMARY

An embodiment is a method includes writing a first set of memory device parameters to a first mode register in a memory device, wherein the first set of memory device parameters correspond to a first frequency, monitoring selected parameters for the memory system while the memory device operates at the first frequency and predicting a second frequency that the memory device will operate at subsequent to the first frequency, the predicting being based on the monitored selected parameters. The method further includes writing a second set of memory device parameters to a second mode register in the memory device, wherein the second set of memory device parameters correspond to the second frequency, receiving a frequency change request at a memory controller associated with the memory device, the frequency change request including a change from operating at the first frequency to operating at a new frequency and updating the first mode register with the second set of memory device parameters from the second mode register responsive to the new frequency being equal to the second frequency.

A further embodiment is a computer program product for operating a memory system, the computer program product including a tangible storage medium readable by a processing circuit and storing instructions for execution by the processing circuit for performing a method. The method including writing a first set of memory device parameters to a first mode register in a memory device, wherein the first set of memory device parameters correspond to a first frequency, monitoring selected parameters for the memory system while the memory device operates at the first frequency, predicting a second frequency that the memory device will operate at subsequent to the first frequency, the predicting being based on the monitored selected parameters and writing a second set of memory device parameters to a second mode register in the memory device, wherein the second set of memory device parameters correspond to the second frequency. The method also includes receiving a frequency change request at a memory controller associated with the memory device, the frequency change request including a change from operating at the first frequency to operating at a new frequency and updating the first mode register with the second set of memory device parameters from the second mode register responsive to the new frequency being equal to the second frequency.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram of a memory system in accordance with an embodiment;

FIG. 2 depicts block diagram of an exemplary process for managing and operating the memory system in accordance with an embodiment;

FIG. 3 is a block diagram of a process for predicting frequency changes in accordance with an embodiment;

FIG. 4 is a block diagram of an exemplary process for initializing and monitoring a memory system in accordance with an embodiment;

FIG. 5 is a block diagram of an exemplary process for changing an operating frequency for a memory system in accordance with an embodiment;

FIG. 6 is a diagram of an exemplary system for dynamic frequency changes to a memory system in accordance with an embodiment; and

FIG. 7 is a diagram of another exemplary system for dynamic frequency changes to a memory system in accordance with an embodiment.

### DETAILED DESCRIPTION

An embodiment is utilized to enable dynamic frequency changes for memory systems. In an embodiment, the memory system includes a memory controller that predicts a frequency subsequent to the current frequency (“predicted frequency”) based on monitored system parameters. In addition, a memory device has a temporary mode register that can contain frequency related settings corresponding to the predicted frequency. If the predicted frequency is correct, the values in the temporary mode register may be “clocked in” to the active mode register to provide a quick transition for operation of the memory device at the new frequency. The active mode register (or “mode register”) includes frequency and non-frequency related settings used for operation of the memory device. An embodiment allows “pre-loading” of frequency-related settings corresponding to a predicted frequency to a temporary mode register prior to receiving a frequency change request, thus providing a reduced-time dynamic frequency change process for the memory system. Further, by enabling a frequency change while the memory system is powered up, the period of time to perform the frequency change is reduced as compared to systems that require a power down and reboot to change frequency. Thus, the improved method and system for dynamic frequency change enables conservation of power by the memory system, improves efficiency and performance.

As discussed herein, mode registers are used to store settings for how a memory device operates at a given time. Active mode registers are the mode registers that are being used at a given time for current operation of the memory device. Temporary mode registers are the mode registers that are used to store settings that may be used in the future for operation of the memory device. For example, memory device settings may be “pre-loaded” into the temporary mode registers for a predicted future operating frequency, where the temporary mode registers are loaded into the active mode registers when the memory device operating frequency changes to the predicted operating frequency.

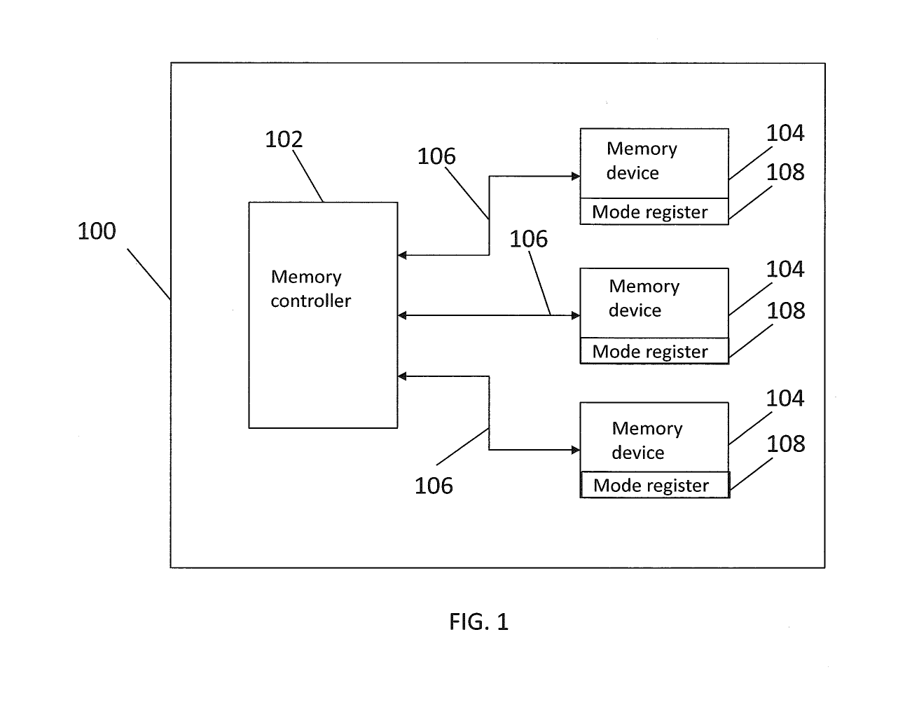

FIG. 1 depicts a block diagram of a memory system 100 in accordance with an embodiment. A memory controller 102 is in communication with a plurality of memory devices 104 via a plurality of memory buses 106. In one embodiment, the memory buses 106 are bi-directional. In another embodiment each memory bus 106 includes two uni-directional busses. In an embodiment, the memory buses 106 transmit clock, data, commands, and a data strobe between the memory controller 102 and the associated memory devices 104, wherein calibration of timing for one or more of these signals improve timing and communication accuracy for the memory system. The calibration may be particularly important when the memory device 104 operating frequency is changed. Operation of the memory devices 104, including signal timing and communication, may be controlled using settings stored within a mode register 108 within each memory device 104.

The examples described herein are directed to memory systems having memory devices such as DRAM memory devices, however embodiments apply to any memory systems that include memory devices that communicate signals across a path, such as memory bus 106.

As used herein, the term “memory controller” refers to any device that controls access to a memory device. A memory controller may be included as part of a processor, as a stand alone processor or in a memory hub or buffer device. In an embodiment, the memory controller also controls the physical layer interface signals (e.g., via additional delay elements) to the DRAM device. In one embodiment, the memory controller includes a buffer to facilitate communication with memory devices. The memory controller and the memory device may require calibration to enable the memory device to properly read and write data. For ease of explanation, the method and system may be discussed with reference to a single memory controller, memory bus and memory device, but may also apply to systems with a plurality of memory controllers, memory buses and memory devices. active mode registertemporary mode register

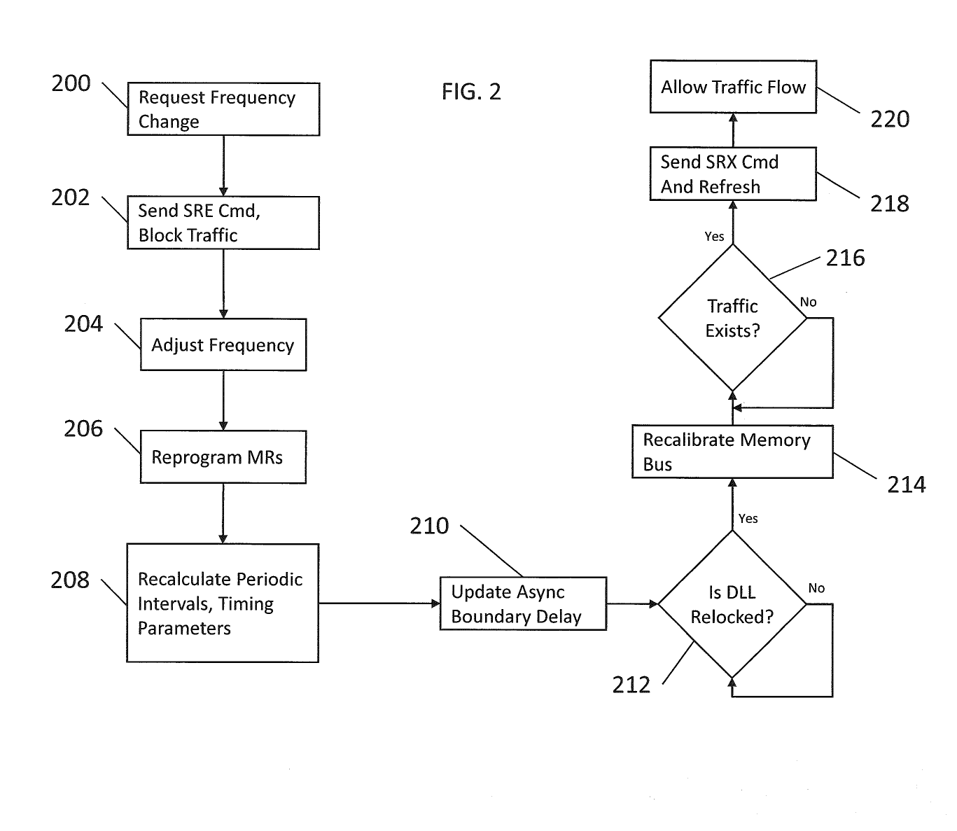

FIG. 2 is a block diagram of an exemplary process for managing and operation of a memory system, such as the memory system 100 of FIG. 1 including one or more memory controller 102 and one or more memory device 104. In block 200, a request for frequency change is received by the memory controller 102. In block 202, the memory controller 102 sends a self-timed refresh enter (SRE) command to the memory device 104. Specifically, the SRE command instructs the memory device 104 (e.g., SDRAM) to perform periodic refreshes of the device to prevent data loss during the frequency change operation. The block 202 also stops traffic to the memory device 104 to ensure no data is sent during the frequency change process. Therefore, the memory device 104 is in a state that allows a frequency change and provides that the memory bus 106 will experience no interruptions during the procedure. In block 204, the frequency is adjusted to one of a plurality of operating frequencies. As discussed below, an initial calibration is performed at each of the plurality of operating frequencies during boot to provide calibration values that are used by the memory system 100 during frequency change operations.

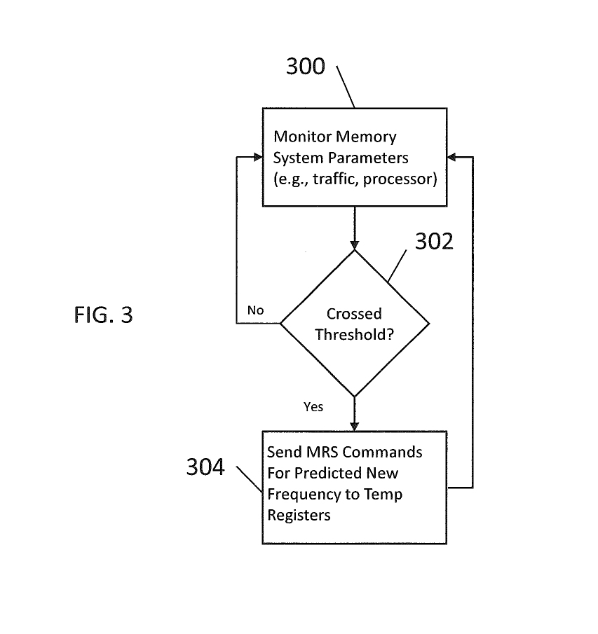

In block 206, commands program or write mode registers (also referred to as “MRs”) on the memory device 104 to alter memory device settings to support the new operating frequency. Detailed descriptions of embodiments to reprogram or change MRs in the memory device 104 are included below with reference to FIGS. 3-7. In block 208, intervals for periodic functions and memory device timing parameters are recalculated to support the new operating frequency. In block 210, registers are updated that control asynchronous boundary crossing delays between the memory controller and interconnect bus between the cores and their cache(s). This block allows systems that run the memory asynchronous to the rest of the processor to adjust the delay between the data being returned by the memory controller and when the “next unit” (whether it is the interconnect bus, the caches or the core itself) is able to access it. In block 212, the memory system 100 checks to see if the DLL is relocked and is stabilized at the new operating frequency. The DLL compares a local clock signal to a reference clock signal and utilizes delay gates to ensure that both are in sync. When they are in sync, the DLL is considered locked. If the DLL is not relocked, then it waits until the DLL is confirmed as relocked. In block 214, if the DLL is relocked communication to the memory device 104 through the memory bus 106 and/or other paths is recalibrated to support the new frequency. In block 216, the memory controller 102 determines if traffic to the memory device 104 exists. If not, the controller waits for the traffic to appear before proceeding to block 218. In block 218, after it is determined that traffic exists, a self-timed refresh exit (SRX) command is sent to the memory device 104. Further, a refresh of the memory device 104 is performed to maintain memory cell data retention. In block 220, the memory controller 102 enables traffic flow to the memory device 104.

FIG. 3 is a block diagram of an exemplary process for monitoring a memory system, such as the memory system 100 of FIG. 1 including one or more memory controller 102 coupled via one or more memory bus 106 to one or more memory device 104. In the embodiment, block 300 monitors one or more system parameters while operating at a first or nominal frequency to predict the next frequency at which the memory device 104 will operate. The system parameters that are monitored may include parameters relating to memory device traffic (reads or writes) and an operating frequency for a processor in the computing system. In an embodiment, memory queues and performance counters may be utilized to determine near future and aggregate past bandwidth usage in the memory device 104. In embodiments, other system components, including the processor, may be monitored to determine if they are entering a dynamic voltage frequency scaling state, where frequency scaling by other components is an indication that the memory system 100 may reduce (scale) its operating frequency. In block 302, one or more of the parameters are compared to one or more threshold value(s) for the parameter(s). In an embodiment, the one or more threshold values represent a minimum change to cause new memory device parameters or settings to be written to the temporary mode register, where the new parameters correspond to a predicted operating frequency. For example, parameters that indicate lower bandwidth requirements for the memory system 100 may be used to predict that the operating frequency will be lowered or reduced. Further, parameters that indicate higher bandwidth requirements for the memory system 100 may be used to predict that the operating frequency will be increased. In an embodiment, the monitored system parameters are used to predict the next or subsequent operating frequency for the memory device 104. The predicted frequency is then used to select corresponding memory device parameters to the temporary mode register. If the one or more selected parameters do not exceed the one or more threshold values, the system resumes monitoring the selected parameters in block 300. In block 304, if one or more of the selected parameters exceeds one or more of the threshold values, the memory system 100 sends a mode register set (MRS) command to the temporary mode register with new memory device parameters or settings that correspond to the predicted new frequency. Accordingly, the memory device parameters provide “pre-loaded” settings that are used to update active mode register parameters dynamically during a frequency change operation, as discussed below. The depicted embodiments may be used in systems with a plurality of temporary mode registers and active mode registers that include memory device settings, however, for ease of explanation, reference may be made to an active mode register and corresponding temporary mode register.

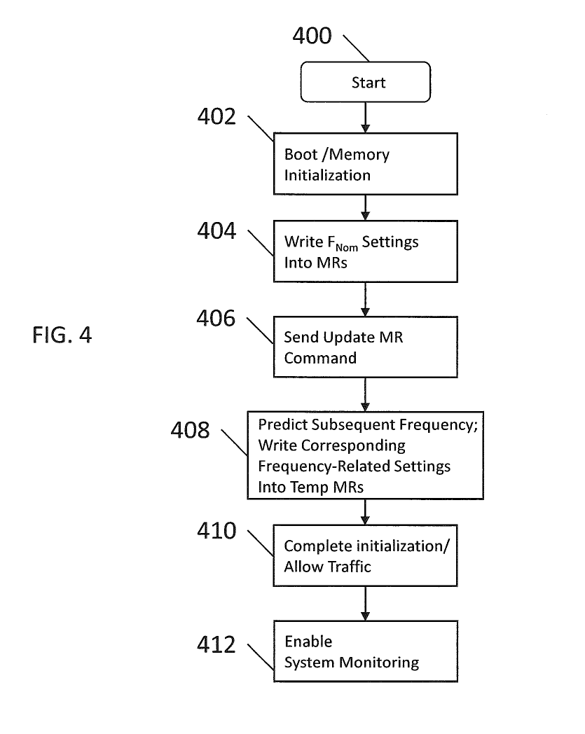

FIG. 4 is a block diagram of an exemplary process for initializing and monitoring a memory system, such as the memory system 100 of FIG. 1. In an embodiment, at least a portion of the blocks are included as part of a frequency change or adjustment procedure, such as the block 206 shown in the memory operation of FIG. 2. In block 400, the system starts and begins initialization. In block 402, the system boots and the memory system 100 is initialized. In block 404, an initial calibration process occurs and a set of memory device parameters corresponding to the current operating frequency, such as a nominal frequency (Fₙₒₘ), are stored in the memory controller 102 and/or memory device 104. In an embodiment, the current memory device parameters are written to the temporary mode register in the memory device 104. In block 406, a command to update memory registers is sent to the memory device 104, thereby copying or writing the memory device parameters in the temporary mode register to an active mode register in the memory device 104. In an embodiment, the temporary mode register is temporary storage for settings related to a memory device operating frequency. The temporary mode register allow the memory system to quickly update the active mode register in the memory device when a frequency change request is received, thereby enabling a dynamic frequency change (i.e., without having to reboot the system), simplifying the frequency change process and reducing the time to execute frequency changes.

In block 408, the controller predicts the subsequent operating frequency for the memory device 104 relative to the current operating frequency (e.g., Fₙₒₘ). For example, the predicting process may include blocks shown in FIG. 3 above, where the prediction is based on monitored system parameters. Further, settings corresponding to the predicted operating frequency are written to the temporary mode register. In block 410, the initialization process is completed and traffic to the memory device 104 is allowed while the memory device 104 is operating at the first operating frequency (e.g., Fₙₒₘ). In block 412, the memory system 100 begins system monitoring to predict a subsequent operating frequency for the system. In an embodiment, the system monitoring process includes blocks of the exemplary process shown in FIG. 3.

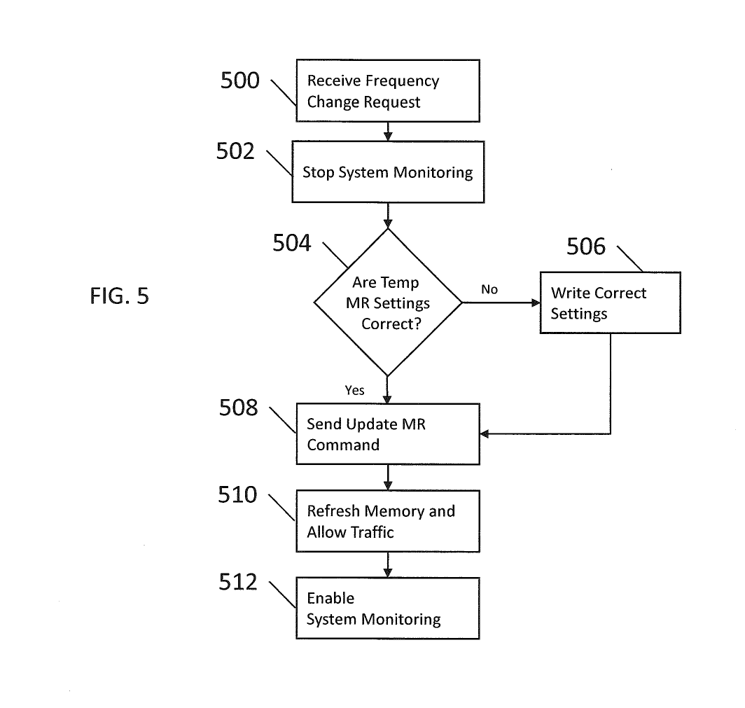

FIG. 5 is a block diagram of an exemplary process for operating a memory system. Specifically the process includes blocks for changing an operating frequency for a memory system, such as the memory system 100 of FIG. 1. In block 500, a frequency change request is received and initiated while traffic to the memory device 104 is stopped. In an embodiment, the frequency change request is a change from a first operating frequency to a subsequent or new operating frequency. In block 502, the system monitoring described in FIG. 3 and block 412 is stopped. In block 504, the new operating frequency is compared to the predicted operating frequency determined by the monitoring process. If the new operating frequency equals the predicted frequency, then the frequency-related temporary mode register settings will match the requested new frequency. If the temporary mode register settings correspond to the requested new frequency, the process advances directly to block 508. In block 506, if the new operating frequency does not equal the predicted frequency the temporary mode register settings are not correct and the settings corresponding to the new operating frequency are written to the temporary mode register, the process then advances to block 508. In block 508, an update memory register (MR) command is sent to the memory device 104. the update MR command causes values in the temporary mode register to be copied or loaded into the active mode register. In an embodiment, a signal for the memory refresh command is sent when a command to exit the self time refresh is send to the memory device. Accordingly, the update MR command and exit self time refresh may be combined into a single command in an example. In another embodiment, the self timed refresh exit command is separate from the update MR command. After the active mode register is updated, the settings therein correspond to the requested new operating frequency. In block 510, all cells the memory device 104 are refreshed and traffic to the device resumes. In block 512, the system monitoring process, such as that described above, is enabled or resumed. Accordingly, the processes shown in FIGS. 2-5 enable a dynamic change of operating frequency for a memory device 104, thereby conserving power and/or improving performance of the memory system 100.

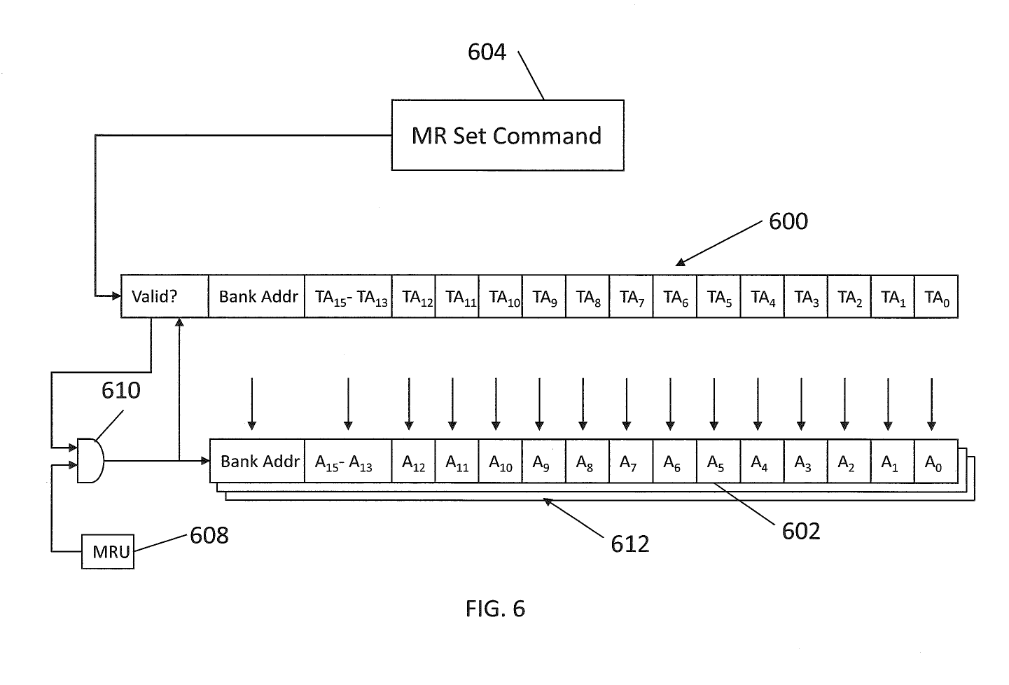

FIG. 6 is a diagram of an exemplary system for dynamic frequency changes to a memory system (e.g., memory system 100), where system monitoring, a temporary mode register and the register update command enable dynamic changes to memory device frequency and settings. The system includes a a temporary mode register 600 and active mode register 602 located in the memory device 104. In an embodiment, a mode register set command 604 from the memory controller 102 writes data to the temporary mode register 600. The mode register set command 604 also flips a valid bit associated with or within the temporary mode register 600, indicating that the data stored therein is valid and ready to be uploaded to the active mode register 602. The bank address indicates the location of the active mode register 602, to ensure that the data is written to the correct mode register in the memory device 104.

In an embodiment, the active mode register 602 is mode register 0 (or “MR0”), where a plurality of mode registers 612 (e.g., “MR0-MR2”) are located in the memory device 104. Accordingly, the mode register set command 604 writes data for the active mode register 602, where all frequency-related settings are consolidated in the single mode register (active mode register 602). Thus, by consolidating all of the frequency-related data into the single mode register, a single clock edge or signal is used to update the active mode register 602 (“a single active mode register”) with the data in the temporary mode register 600 (“a single temporary mode register”) related to the new requested frequency. The mode register update command 608 is sent by the memory controller 103 and is combined with the valid bit (indicating the data in temporary mode register 600 is ready) in an and function 610 to update the active mode register 602 with the data from the temporary mode register 600. In an embodiment, TA₀-TA₁₅ are frequency related memory device parameters within the temporary mode register 600 copied to A₀-A₁₅ within the active mode register 602 when the update command is received by the memory device 104. After the data is updated from the temporary mode register 600 to the active mode register 602, the valid bit is flipped again to indicate the data stored in the temporary mode register 600 is no longer ready to copy.

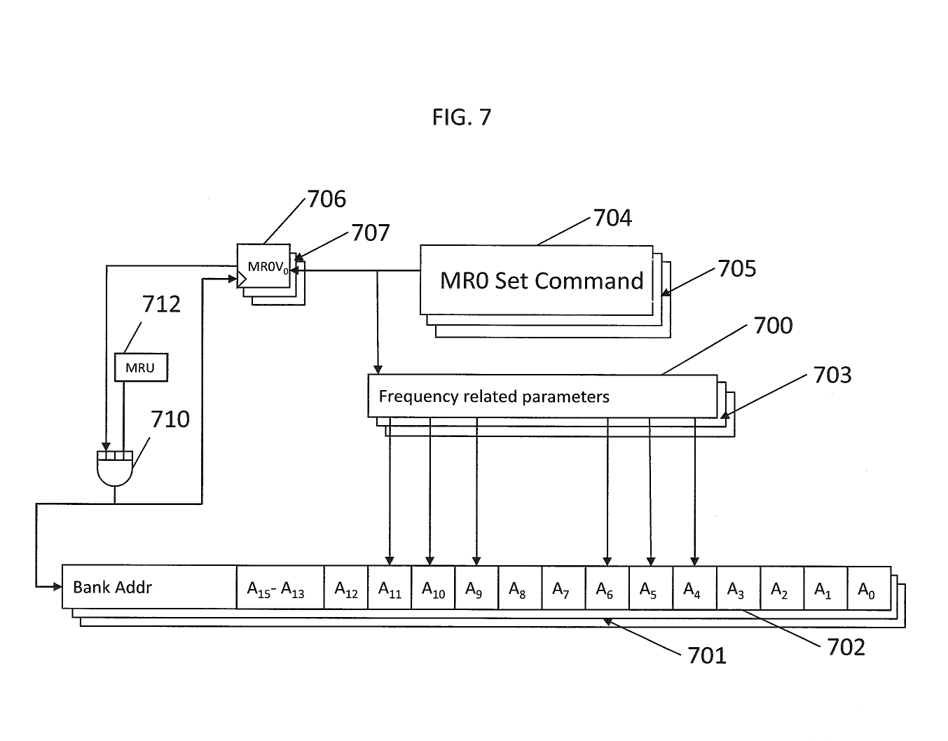

FIG. 7 is a diagram of another exemplary system for dynamic frequency changes to the memory system 100. In the embodiment, frequency-related parameters are located in a plurality active mode registers 701. Accordingly, a plurality of temporary mode registers 703 store frequency-related settings as compared to the consolidated single mode register discussed above. The frequency-related settings in temporary mode registers 703 correspond to the predicted subsequent frequency for the memory system 100. As depicted, an active mode register 702 (MR0 or mode register 0) and a corresponding temporary mode register 700 including frequency related parameters for MR0 are shown. It should be understood that settings for mode registers and their locations within the mode registers may vary depend on the application and memory architecture. Block 704 is a command from the memory controller 102 to set or write data for temporary mode register 700. In addition, the command block 704 sets a valid bit in valid bit block 706 indicating frequency related parameters for the temporary mode register 700 are ready for copying to active mode register 702. Block 705 corresponds to a plurality of MR set commands for setting values for each of the temporary mode registers 703. In addition, blocks 707 are the plurality of valid bits corresponding to each of the plurality of temporary mode registers 703, where each valid bit indicates the register has been written and is ready.

After each of the temporary mode registers 703 are set and valid bits 707 indicate they are ready, an and function 710 receives the valid bit inputs and a mode register update command 712 from the memory controller 102, causing each of the temporary mode registers 703 to be copied to corresponding active mode registers 701. In an embodiment, the frequency related memory device parameters stored in one or more of the temporary mode registers 703 are copied to a subset of the mode registers A₀-A₁₅ within the active mode register 702 that correspond to the frequency related settings. In embodiments, the non-frequency related settings may be written directly to the active mode registers 701.

In another memory system embodiment, a buffer for all active mode registers, where each active mode register includes non-frequency and frequency related settings is used. As compared to the embodiment of FIG. 6, the buffer for all active mode registers may be a plurality of temporary mode registers 600 corresponding to each active mode register. Included in the buffer are valid bits (e.g. 4 valid bits for MR0-MR3) that ensure each active mode register with frequency related parameters is written to the buffer (or temporary mode registers) prior to clocking in the values for all active mode registers.

An embodiment allows “pre-loading” of frequency-related settings corresponding to a predicted frequency to a temporary mode register prior to receiving a frequency change request, thus providing a dynamic frequency change process for the memory system. Further, by enabling a frequency change while the memory system is powered up, the period of time to perform the frequency change is reduced as compared to systems that require a power down and reboot to change frequency.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Further, as will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for operating a memory system, the method comprising:
writing a first set of memory device parameters to a first mode register in a memory device, wherein the first set of memory device parameters correspond to a first frequency;
monitoring selected parameters for the memory system while the memory device operates at the first frequency;
predicting a second frequency that the memory device will operate at subsequent to the first frequency, the predicting being based on the monitored selected parameters;
writing a second set of memory device parameters to a second mode register in the memory device, wherein the second set of memory device parameters correspond to the second frequency;
receiving a frequency change request at a memory controller associated with the memory device, the frequency change request comprising a change from operating at the first frequency to operating at a new frequency; and
updating the first mode register with the second set of memory device parameters from the second mode register responsive to the new frequency being equal to the second frequency.

2. The method of claim 1, wherein receiving the frequency change request at the memory controller further comprises stopping the monitoring of the selected parameters.

3. The method of claim 2, wherein updating the first mode register with the second set of memory device parameters comprises resuming monitoring of the selected parameters.

4. The method of claim 1, wherein writing the second set of memory device parameters to the second mode register comprises writing frequency related parameters for each of a plurality of mode registers in the memory device and wherein updating the first mode register with the second set of memory device parameters comprises updating the frequency related parameters for each of the plurality of mode registers in the memory device.

5. The method of claim 1, wherein writing the second set of memory device parameters to the second mode register comprises writing frequency related parameters to a single temporary mode register in the memory device and wherein updating the first mode register with the second set of memory device parameters comprises updating a single active mode register in the memory device.

6. The method of claim 1, wherein monitoring selected parameters for the memory system comprises monitoring memory traffic and a processor operating frequency.

7. The method of claim 1, wherein predicting the second frequency that the memory device will operate at subsequent to the first frequency comprises predicting the second frequency based a comparison of on one of the selected parameters to a selected threshold.

8. The method of claim 1, wherein updating the first mode register comprises sending a signal to load the active mode register from the second mode register, the signal being sent when a self timed refresh exit command is sent.

9. A computer program product for operating a memory system, the computer program product comprising:
a tangible storage medium readable by a processing circuit and storing instructions for execution by the processing circuit for performing a method comprising:
writing a first set of memory device parameters to a first mode register in a memory device, wherein the first set of memory device parameters correspond to a first frequency;
monitoring selected parameters for the memory system while the memory device operates at the first frequency;
predicting a second frequency that the memory device will operate at subsequent to the first frequency, the predicting being based on the monitored selected parameters;
writing a second set of memory device parameters to a second mode register in the memory device, wherein the second set of memory device parameters correspond to the second frequency;
receiving a frequency change request at a memory controller associated with the memory device, the frequency change request comprising a change from operating at the first frequency to operating at a new frequency; and
updating the first mode register with the second set of memory device parameters from the second mode register responsive to the new frequency being equal to the second frequency.

10. The computer program product of claim 9, wherein receiving the frequency change request at the memory controller further comprises stopping the monitoring of the selected parameters.

11. The computer program product of claim 9, wherein updating the first mode register with the second set of memory device parameters comprises resuming monitoring of the selected parameters.

12. The computer program product of claim 9, wherein writing the second set of memory device parameters to the second mode register comprises writing frequency related parameters for each of a plurality of mode registers in the memory device and wherein updating the first mode register with the second set of memory device parameters comprises updating the frequency related parameters for each of the plurality of mode registers in the memory device.

13. The computer program product of claim 9, wherein writing the second set of memory device parameters to the second mode register comprises writing frequency related parameters to a single temporary mode register in the memory device and wherein updating the first mode register with the second set of memory device parameters comprises updating a single active mode register in the memory device.

14. The computer program product of claim 8, wherein monitoring selected parameters for the memory system comprises monitoring memory traffic and a processor operating frequency and wherein predicting the second frequency that the memory device will operate at subsequent to the first frequency comprises predicting the second frequency based on a comparison of one of the selected parameters to a selected threshold.

15. A system for operating a memory system, the system comprising:
a memory controller and a memory device, the system configured to perform a method comprising:
writing a first set of memory device parameters to a first mode register in a memory device, wherein the first set of memory device parameters correspond to a first frequency;
monitoring selected parameters for the memory system while the memory device operates at the first frequency;
predicting a second frequency that the memory device will operate at subsequent to the first frequency, the predicting being based on the monitored selected parameters;
writing a second set of memory device parameters to a second mode register in the memory device, wherein the second set of memory device parameters correspond to the second frequency;
receiving a frequency change request at a memory controller associated with the memory device, the frequency change request comprising a change from operating at the first frequency to operating at a new frequency; and
updating the first mode register with the second set of memory device parameters from the second mode register responsive to the new frequency being equal to the second frequency.

16. The system of claim 15, wherein receiving the frequency change request at the memory controller further comprises stopping the monitoring of the selected parameters.

17. The system of claim 16, wherein updating the first mode register with the second set of memory device parameters comprises resuming monitoring of the selected parameters.

18. The system of claim 15, wherein writing the second set of memory device parameters to the second mode register comprises writing frequency related parameters for each of a plurality of mode registers in the memory device and wherein updating the first mode register with the second set of memory device parameters comprises updating the frequency related parameters for each of the plurality of mode registers in the memory device.

19. The system of claim 15, wherein monitoring selected parameters for the memory system comprises monitoring memory traffic and a processor operating frequency.

20. The system of claim 15, wherein predicting the second frequency that the memory device will operate at subsequent to the first frequency comprises predicting the second frequency based on a comparison of one of the selected parameters to a selected threshold.
